(19) United States
(12) Patent Application Publication
(10) Pub. No.: US 2004/0221313 A1
(43) Pub. Date: Nov. 4, 2004

(54) Method and apparatus for augmenting functionality of broadcast content receivers

(76) Inventors: Mark Depietro, Harleysville, PA (US); Carl McGrath, Chalfont, PA (US); Reem Safadi, Horsham, PA (US); Mark Kolber, Churchville, PA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/777,703

(22) Filed: Feb. 12, 2004

Related U.S. Application Data
(60) Provisional application No. 60/448,155, filed on Feb. 14, 2003.

(51) Int. Cl. H04N 7/173; G06F 13/00; H04N 5/445; G06F 3/00

(52) U.S. Cl. 725/105; 725/120; 725/37

(57) ABSTRACT

Commands received in a set-top-box are forwarded upstream to an augmentation unit. The augmentation unit executes commands. Record and play commands may enable personal video recording using a set-top-box as a command interpreter. Firmware patches enable a set-top-box to forward commands using a network protocol.

### FIELD OF THE INVENTION

This invention relates generally to upgrading broadcast content receiver capability; and specifically to providing a secondary command execution capability for such a receiver.

### BACKGROUND OF THE INVENTION

Cable television had very humble beginnings. Originally, cable television occupied an extremely narrow niche in the world of television broadcasting. Serving isolated communities where it was either impractical or simply infeasible to receive broadcast television signals, small companies began establishing distribution systems using coaxial cable. Capitalizing on a true need, these small and generally independent cable television companies typically installed a receiving apparatus atop a hill, or some other place of high elevation where television broadcast signals could be captured from the ether. In order to propagate the captured broadcast signals, a bank of radio frequency (RF) tuners are utilized; each receiving a separate broadcast transmission. The output of these tuners is normally converted to an intermediate frequency (IF). In many cable television systems, the IF signal generated by each individual tuner is converted to a distribution frequency, i.e. a “channel” identified by a number. These could then be disseminated through a distribution network comprising the cable television system, i.e. the cable.

Early cable television system operators had many problems to overcome. One was the prevention of interference with commercial, over-the-air broadcast transmissions. This was solved by shifting the IF frequency used to carry a signal captured from a particular broadcast station to another frequency, wholly different from that originally used by the broadcast station. For instance, if a cable television system wanted to capture “Channel 2”, it may have distributed the captured signal at a frequency normally associated with “Channel 18”. Hence, where the original broadcast television transmissions were received on one set of frequencies, a wholly different set of frequencies would typically be used to distribute the television signals to cable television system subscribers, i.e. those people willing to pay for the convenience of cable television. This tactic helped to significantly reduce the potential of a retransmitted signal interfering with the original broadcast signal.

In an era where television receiver capabilities were limited to begin with, the channel mapping used to preclude interference often led to the use of frequencies that could not be received by a standard television receiver (TV). For example, if the distribution frequencies were in the so-called “UHF” band (ultra high frequency), many older TV sets simply could not receive the signals generated by a cable television system. This reshuffling of channel frequencies also resulted in much confusion at the user level. For instance, if a subscriber wanted to watch Channel 2, the subscriber would need to tune their television to Channel 18. In order to prevent this type of confusion and to enable older TV sets to receive cable television signals, cable television system operators quickly realized that some form of intermediate processing was required to allow television viewers to be able to watch “Channel 2” by actually tuning to “Channel 2” instead of “Channel 18”.

All of this history may sound as if it is not germane to any problem at hand, but it is helpful to understand the eventual introduction of the so-called “set-top box”. An early set-top box comprised a tuner that could be commanded to a particular channel. Nothing earth-shattering about that, except that the set-top box's tuner could tune all of the frequencies that a standard TV set could not otherwise receive. Also, cable television system operators could program the tuner to mask-out all of the channel reshuffling that was going on. For example, if the cable television system disseminated Channel 2 on a frequency ordinarily associated with Channel 18, a user could select “Channel 2” on the set-top-box. Even though the dial read “Channel 2”, the tuner in the set-top-box would actually be commanded to receive Channel 18. The output of the tuner comprising the set-top box could then be converted to a modulated carrier signal at a particular service channel. This could be conveyed to a television receiver used by the subscriber. For instance, it has been a common convention to allow a set-top-box to generate a modulated carrier signal on either Channel 3 or Channel 4. The subscriber, of course, would need to tune their television receiver to the service channel and then use the set-top-box to select channels as the television viewer fancies.

With the passage of time, cable television systems began to enjoy more popularity. Even in communities where over-the-air broadcasts could easily be received, many consumers found cable television more convenient compared to the work and effort involved in maintaining a television antenna perched on the roof of a house or apartment. Ours may be the last generation that remembers Saturday afternoons with dad, rotating the aerial until picture quality was just so.

Today, it is almost the exception rather than the rule that individual homes and apartments should install and maintain television aerials in order to receive broadcast television content. This is because cable television offers other benefits. For instance, cable television systems provide not only local broadcast signals, but foreign television programming and radio signals are also typically distributed to cable television system subscribers. Modernly, cable television systems seem to truly dominate the marketplace when it comes to delivery of television and radio content to individual homes across the nation. Other services, such as computer data network access (i.e. cable modems), specialized programming channels and even the ability to order and view first-run movies have all led to the increasing popularity of cable television.

As cable television systems and the services they offer have evolved, so have set-top-boxes. Originally deployed to provide a channel frequency mapping mechanism, set-top-boxes have been updated in order to accommodate new programming features and services offered by cable television service providers. This steady evolution has resulted in the obsolescence of many set-top-boxes. For instance, early set-top-boxes became obsolete when encrypted television programming was made available to cable television system subscribers. In order to receive encrypted programming, television users were required to upgrade to a new set-top-box that included a decryption capability. This is just one example of an evolutionary advance that has required upgrade of a set-top box installed at a subscriber's premises.

Digital broadcast television is gaining more popularity because it offers higher picture fidelity and increased programming bandwidth. In order to allow subscribers to receive digital broadcast television, new set-top-boxes are now being installed at subscriber's premises at a phenomenal rate.

Compared to the simple set-top-boxes of yesteryear, it takes an extremely sophisticated electronic circuit to receive digital broadcast television. First, an RF tuner is used to selectively amplify a single, digitally modulated carrier signal. The set-top box typically includes a demodulator; this recovers a time-multiplexed plurality of digital content streams from the digitally modulated carrier. One of these content streams typically represents a distinct television channel. Additional circuitry is required to select a particular content stream from the output of the demodulator. The selected content stream is generally in the form of a compressed video signal. For instance, it may be encoded in a form known as “MPEG” (a compression standard defined by the Moving Pictures Expert Group).

A digital set-top-box may also include a high-powered processor. A high-powered processor is usually provided in the set-top box in order to decompress the compressed; digital content stream. And, where the digital content stream is encrypted as a means of precluding content piracy, the high-powered processor may also execute decryption algorithms that may be used to decipher the encrypted content stream before it is presented to a television viewer.

It is clear that a set-top box that is capable of receiving digital broadcast television represents a very powerful computing platform. A modern set-top-box may also include capabilities for communicating with a “head-end”. The head-end typically comprises the equipment necessary to capture broadcast television signals from the ether or other distribution sources so that it may be distributed to individual subscribers connected to the cable television system. In many cases, a digital set-top-box needs to be able to communicate with the head-end in order to allow a subscriber to order additional services that may be offered by the cable television service.

As cable television continues to evolve under commercial pressures and public scrutiny, cost containment has become a major concern. In the past, as additional services were introduced, the associated obsolescence of set-top-boxes was easier to absorb. This was due to the fact that simple set-top-boxes were not very expensive; in some cases just a tuner in a box. Today, as additional cable services have been introduced, it is almost unthinkable to discard and then replace sophisticated electronic assemblies like digital set-top-boxes.

In many cases, additional cable services can be offered using the existing hardware incorporated into a set-top-box. This is often done by updating the “firmware” in the set-top-box by way of the head-end communications capability supported by the box. New firmware, which is a collection of software modules that are used to define what the processor in the set-top-box is supposed to do, can be conveyed from the head-end and stored in a program memory comprising the set-top-box. Once the new firmware is loaded in this manner, new cable service features can be supported without the need to replace the set-top-box deployed at the subscribers premises.

Firmware upgrades can only be effective so long as the hardware in a set-top-box is capable of rudimentary support of a new cable service or function. In the case where additional hardware is required to support a new feature or cable service, there is the perplexing challenge of augmenting existing set-top-box hardware through a cost-effecting strategy. Any such strategy must preserve the use of existing set-top-box hardware already deployed in millions upon millions of homes throughout the world.

### SUMMARY OF THE INVENTION

The present invention comprises a method for expanding the functions of a content receiver, for instance a set-top box or television set, by receiving commands from a content receiver that is downstream from an augmentation unit. The term “downstream” is, by convention, relative to the head-end of a cable system. In order to receive commands from the downstream content receiver, it may be necessary to first configure the downstream content receiver enabling it to forward commands upstream to the augmentation unit. This may be accomplished by installing a “firmware” patch into the content receiver. Alternatively, a content receiver may be originally manufactured with firmware enabling the forwarding of commands.

Once the downstream content receiver is properly configured, it receives commands and directs those commands to the upstream augmentation unit. The commands are typically received from a user. For example, commands may be received from a user by means of a remote control. Commands may also be generated by the downstream content receiver itself.

When a downstream content receiver receives a command, original firmware or a firmware patch enables it to forward the command to an augmentation unit upstream by first encapsulating the command in a data packet. In the case where a command is to large to encapsulate into a single data packet, the command may be fragmented into a plurality of data packets. A modulated carrier signal representing one or more data packets is generated and conveyed to the upstream augmentation unit.

The augmentation unit receives the modulated carrier signal and demodulates that signal. This results in a digital bit stream that is framed into data packets. Individual data packets are then assembled into network messages representing commands received from a downstream content receiver. Once a command is received it is an executed, unless it is targeted to a different augmentation unit located upstream from the first augmentation unit. In this case the first augmentation unit forwards the command upstream. Note that where additional capability is required, future enhancements can be made by “augmenting the augmentation unit” using the method of the present invention.

The method of the present invention provides for augmenting a downstream content receiver with various types of commands and capabilities. For example, one set of capabilities defined by the method of the present invention is that of a personal video recording system. An augmentation unit that provides personal video recording responds to various commands including, but not limited to a “record” command and a “play” command.

When a “record” command is received from a downstream content receiver, the method provides for receiving a content stream from an upstream signal source. This content stream is then recorded. Once the content stream is recorded, it can be played back when necessary.

According to the present method, when a “play” command is received from a downstream content receiver, previously recorded content streams can be retrieved and then directed to the content receiver that dispatched the play command. Upon determining what content should be played, the retrieved content stream is used to generate a modulated carrier signal. This modulated carrier signal can then be directed downstream either by combining the modulated carrier signal with other modulated carriers or by selecting the modulated carrier in lieu of other modulated carriers. It should be noted that these other modulated carriers may be received in an augmentation unit from an upstream signal source and then forwarded to a downstream content receiver.

The present invention also comprises an augmentation unit that may be installed upstream from a content receiver for the purpose of augmenting the capabilities of the downstream content receiver. The augmentation unit of the present invention typically comprises a downstream interface and a command executive. The downstream interface allows the augmentation unit to receive commands from a downstream content receiver. These can then be executed by the command executive.

If a command is not targeted to a particular augmentation unit, a command forwarding unit in the augmentation unit forwards the command upstream using an upstream interface that may further comprise the invention. A modulator in the upstream interface generates a modulated carrier signal according to data packets comprising the command to be forwarded and a multiplexing filter directs the modulated carrier into an upstream medium path.

In some embodiments, the augmentation unit provides a content receiver initiation unit. The content receiver initiation unit communicates with a downstream content receiver and configures the downstream content receiver to forward commands to the augmentation unit. This is typically done if the downstream content receiver has not been previously configured to forward commands according to the teachings of the present invention. The content receiver initiation unit is able to install a firmware patch into the content receiver. As an alternative, the downstream content receiver may be enabled to forward commands as a standard function of original firmware comprising the content receiver.

One embodiment of a firmware patch that the augmentation unit can install in a downstream content receiver provides a module for communicating a command upstream from a content receiver to an augmentation unit by means of a network protocol. This network protocol module receives command messages and causes a processor in the content receiver to fragment a command message into one or more data packets. These can then be conveyed to a modulator in the content receiver. The modulator generates a modulated upstream data carrier signal that can be conveyed to an upstream augmentation unit.

The downstream interface in an augmentation unit typically comprises a data packet receiver and a message assembly unit. A modulated carrier signal received from a downstream content receiver is demodulated in order to generate a digital bit stream. A data packet framer generates data packets from the digital bit stream. The data packet receiver can then receive data packets addressed to the augmentation unit. These can be assembled into command messages by the message assembly unit. Data packets representing a command not addressed to a particular augmentation unit can be forwarded upstream as described above.

An augmentation unit can receive a wide variety of commands from a downstream content receiver or other apparatus. According to one embodiment of the invention, the augmentation unit is capable of processing a “play” command. In an alternative embodiment of the invention, the augmentation unit is capable of processing a “record” command. These embodiments of the augmentation unit further comprise a content storage unit.

Upon receiving a “record” command, the augmentation unit begins receiving a content stream from an upstream signal source. This content stream may then be directed to the content storage unit. Once the content stream is stored in the content storage unit, it may be retrieved at a later time for presentation to a user.

When the augmentation unit of the present invention receives a “play” command it first determines what content must be played. The content storage unit begins directing the requested content to a downstream interface. The downstream interface allows the content stream to be directed to a downstream content receiver so that it may be presented to a user. The downstream interface generates a modulated carrier signal according to the content stream. This modulated signal may be directed to a downstream content receiver either in lieu of or in combination with other modulated carrier signals.

### BRIEF DESCRIPTION OF THE DRAWINGS

The foregoing aspects are better understood from the following detailed description of one embodiment of the invention with reference to the drawings, in which:

FIG. 1 is

### DETAILED DESCRIPTION OF THE INVENTION

According to the present method, a content receiver installed at a subscriber's facility may receive a command from a user that it can not independently process. Accordingly, this command may be directed upstream to an augmentation apparatus that may expand the functionality of the content receiver.

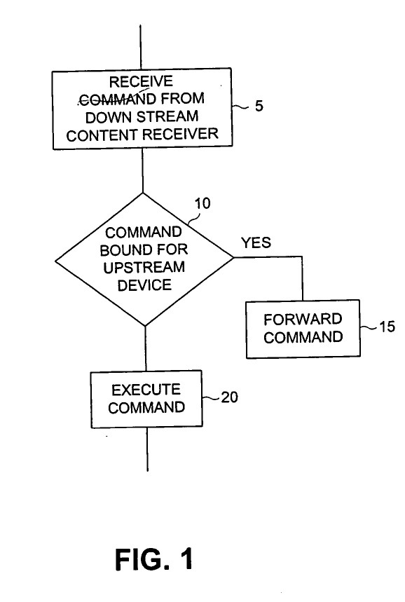

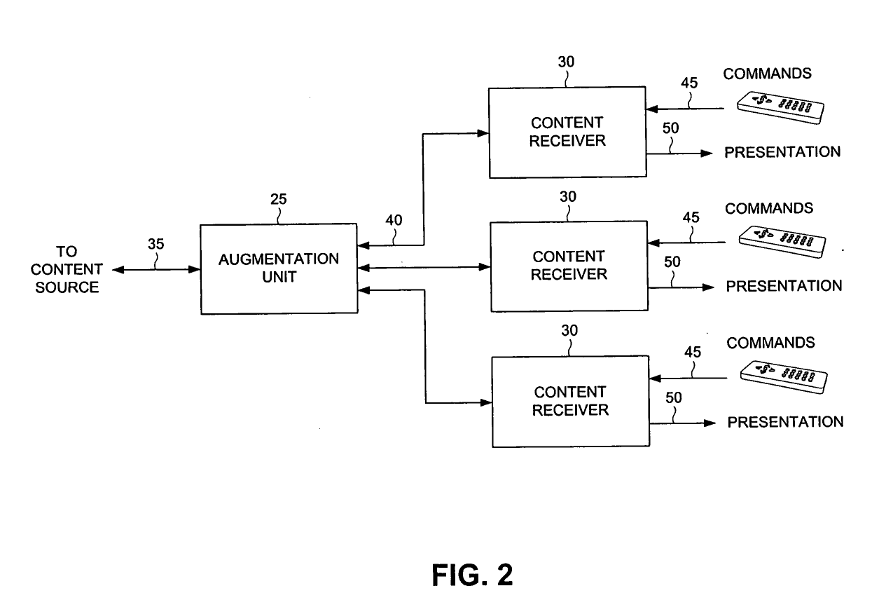

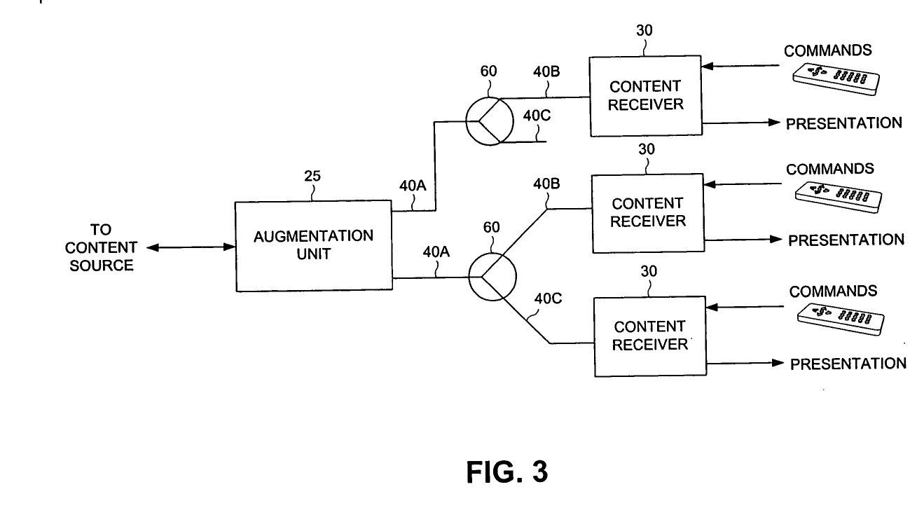

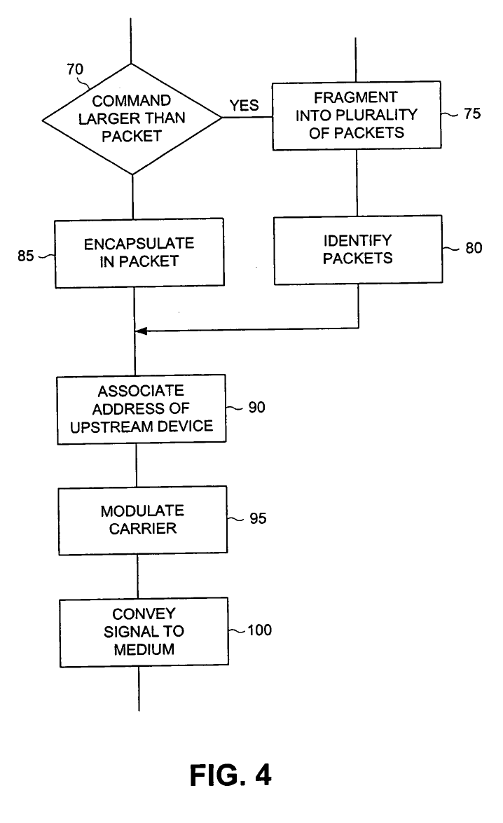

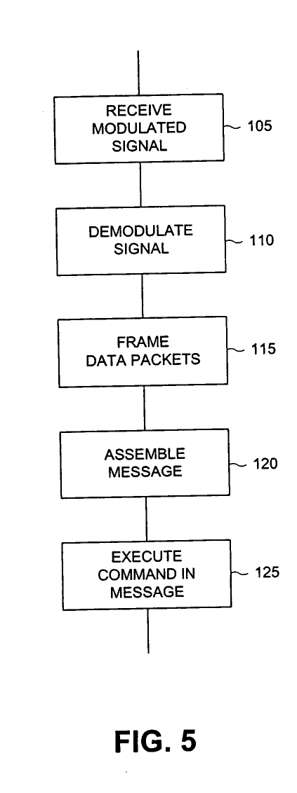

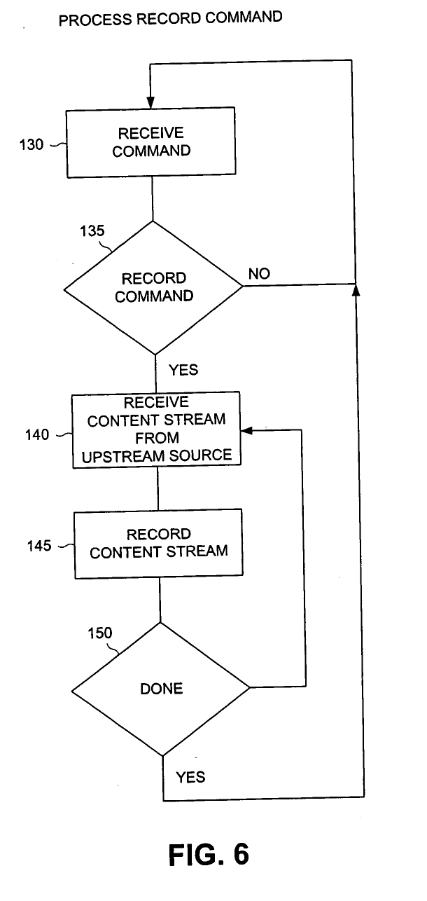

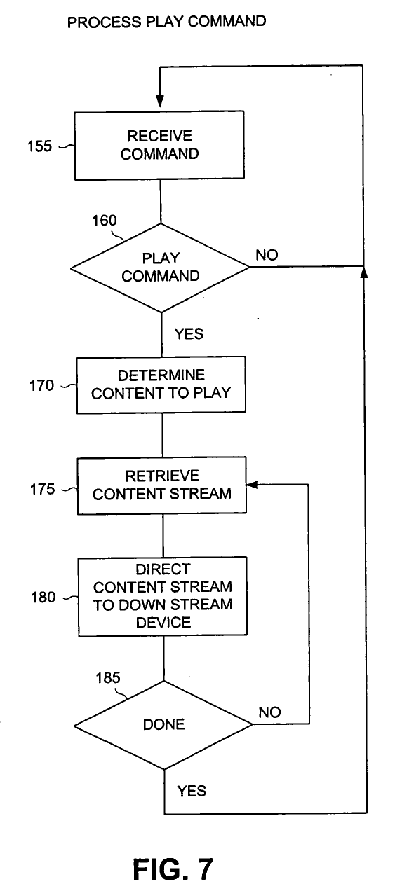

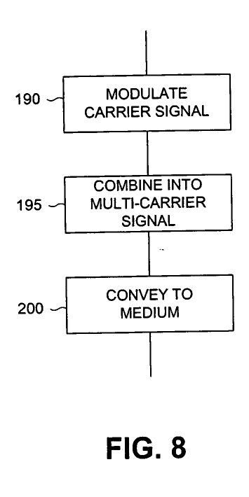

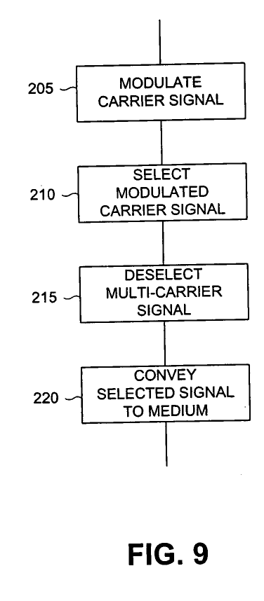

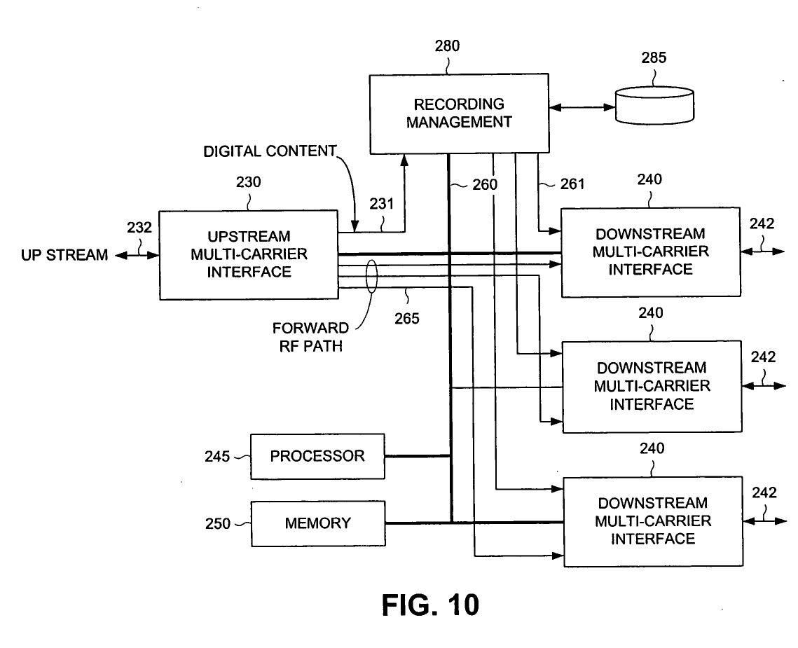

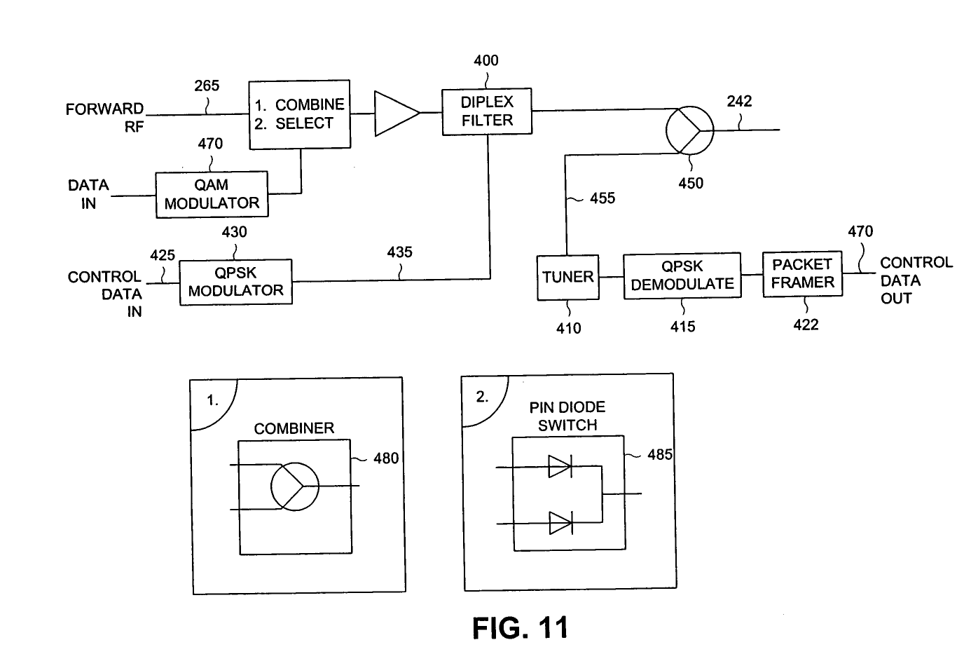

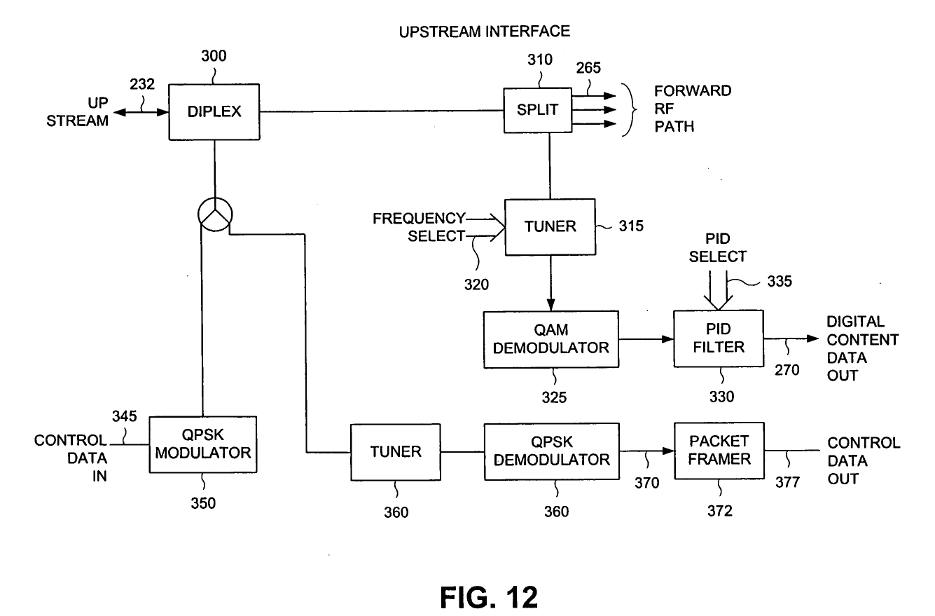

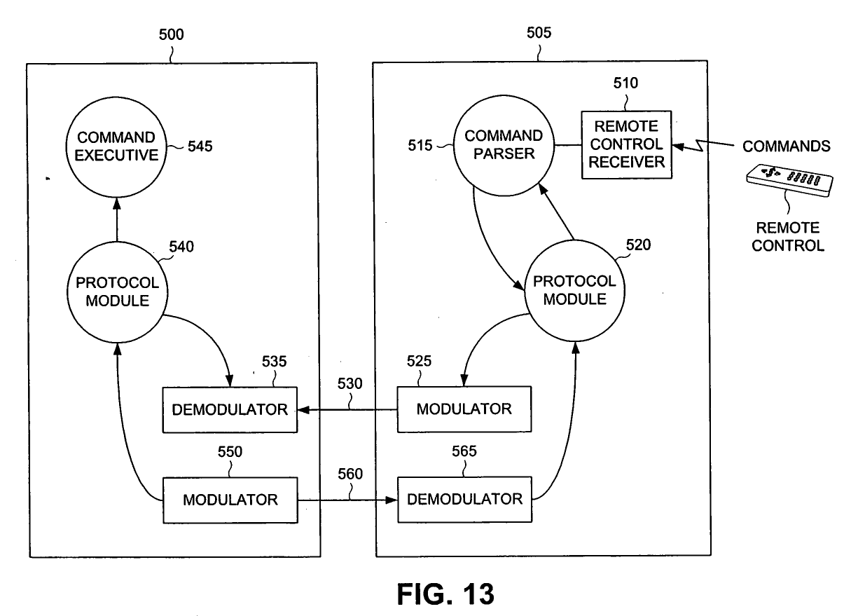

FIG. 1 is flow diagram that depicts one illustrative method for adding additional command capability to existing content receivers according to the present invention. A command may be received in an augmentation apparatus from a downstream content receiver (step 5). According to various derivatives of the present method, a content receiver may comprise a set-top-box. It may also comprise a digital set-top-box. In yet other variations of the present method, a downstream content receiver may comprise a “cable-ready” television receiver that may further comprise digital broadcast reception capability. It should be noted that the method of the present invention is not intended to be limited to applications where content is distributed using digital techniques. In fact, many variations of the present method are applicable to “analog” distribution and content reception paradigms.

If a command is received and that command is targeted for the particular augmentation apparatus that received the command (step 10), the present method provides that the command should be executed (step 20). Otherwise, the command may be forwarded upstream (step 15). In this case, the command may be received by a second augmentation apparatus or perhaps by the head-end of a cable television system.

FIG. 2 is a pictorial block diagram that illustrates one example method for connecting one or more content receivers to an augmentation apparatus according to the present invention. In most cable television systems, a head-end serves as a content source. By convention, content flows “downstream” from the content source to a subscriber's facility. According to one variation of the present method, an augmentation unit 25 may comprise an intelligent content manager. It should be noted that the augmentation unit 25 may take on many different forms. For example, an intelligent content manager as described here may comprise personal video recording functionality. In another example embodiment of an augmentation unit, Internet access may be provided. It should be further noted that the scope of the present invention is not intended to be limited to any particular embodiment of an augmentation unit but is rather intended to include methods and apparatus that augment functionality and command execution capability of content receivers according to the teachings presented here.

Generally, an augmentation unit 25 may be disposed between a content source (for example, a cable television system head-end) and a content receiver 30. Thus, from the perspective of the augmentation unit 25, a path to the content source may be considered an upstream path 35 whereas a path to a content receiver may be considered a downstream path 40. Hence, content receivers are said to be “downstream” of the augmentation unit 25. Additional augmentation units may be disposed between a first augmentation unit and the content source. These additional augmentation units are said to be upstream augmentation apparatus.

According to one example method of the present invention, commands 45 may be received by a downstream content receiver 30. Commands may be received from a user by means of a remote control or other user interface device, for example a keyboard. The scope of the present invention is not intended to be limited in application to any particular means of command reception. In some cases, the content receiver 30 may process the commands 45 locally. In those cases were a command cannot be processed locally by the content receiver 30, the command may be forwarded upstream to the augmentation unit 25.

According to one example method of the present invention, a content receiver 30 may be connected to the augmentation unit 25 using a “point-to-point” 40 connection. In a typical subscriber facility, this point-to-point connection may be accomplished using coaxial cable, but other forms of connectivity are within the scope of the present invention. Content disseminated by the content source may normally be received by the augmentation unit 25 from the upstream path 35 and propagated to individual content receivers 30 using corresponding point-to-point downstream paths 40.

As a matter of information, content may be distributed from the content source using either analog or digital techniques. When analog distribution is employed, a television signal in the form of an analog waveform may be used to modulate a carrier signal and a plurality of carrier signals at different frequencies are typically combined so that they may be collectively conveyed by a single medium. Digital content distribution typically multiplexes a plurality of compressed television signals into a single transport stream. This transport stream may be used to modulate a single carrier signal, effectively allowing several television channels to be conveyed in the same amount of bandwidth as that required to carry a single analog channel. The carrier signal used to convey digital content may be modulated in amplitude and in phase. One such technique is known as quadrature amplitude modulation (QAM).

Additionally, cable television systems typically reserve carrier frequencies for the purpose of supporting communications between the head-end and other system components, such as set-top boxes. Digital data is typically used to modulate a carrier signal at these frequencies. The modulated carrier signal may then be conveyed to a remote device affecting the conveyance of digital information. In many cases, distinct frequencies are used to convey downstream and upstream data. Typically, the carrier signals are modulated using a technique called NEED DEFINITION OF (i.e. “QPSK”). For the purposes of this description, a carrier signal flowing in the downstream direction may be referred to as a “downstream data carrier”. The upstream carrier may be called an “upstream data carrier”.

In order to effectively manage the conveyance of digital information, components comprising a cable television system typically use network protocols similar to that used in computer networking. Using these techniques, data that needs to be conveyed to a remote component may be assembled into a network message. The network message may be addressed to a specific device affiliated with the cable television system. The network message may then be directed to a lower level network protocol system. This normally fragments the message into one or more data packets that can then be used to modulate either an upstream or downstream data carrier, depending on the address associated with the network message.

FIG. 3 is a block diagram that depicts one illustrative technique for connecting a content receiver to an augmentation unit according to one alternative method of the present invention. According to one illustrative variation of the present method, downstream paths from an augmentation unit may be used to connect two or more downstream content receivers. For instance, a downstream path 40A may be split using a signal splitter 60 into two downstream paths (40B and 40C). This variation of the present method supports the attachment of more content receivers 30 where an augmentation apparatus 25 has a limited number of downstream interfaces.

FIG. 4 is a flow diagram that depicts one example method according to the present invention of forwarding commands to an upstream command augmentation unit. One derivative method of the present invention provides for configuring a downstream content receiver so that the downstream content receiver is able to forward commands to an upstream augmentation unit. According to one variation to the present method, this may be accomplished by updating a firmware program in the content receiver 30. By updating the firmware, a downstream content receiver may then recognize commands 45 that an augmentation unit 25 may be capable of executing.

Generally, the downstream content receiver may be configured in this manner if it has not been previously configured to forward commands to the upstream augmentation unit 25. Updating the firmware program may be accomplished either by installing a firmware patch, wherein existing firmware in the content receiver is wholly of partially retained and a new firmware image designed to be initiated by the existing firmware is installed in the content receiver. In one alternative method of the present invention, the firmware in the content receiver may be replaced entirely. In yet another variation of this method, command forwarding firmware may be installed in a content receiver when it is originally manufactured.

According to one derivative method of the present invention, firmware enabling the forwarding of commands to an upstream augmentation unit may minimally cause a processor in a content receiver to convey a command by means of a network protocol. Accordingly, updated firmware may cause the processor in the content receiver to determine if a message command is larger than a data packet used by the network protocol to convey information (step 70). If the command message is larger than a single data packet, the method of the present invention provides for installing firmware in the content receiver that minimally causes the processor therein to fragment the command message into a plurality of identifiable data packets (steps 75 and 80). A single data packet (step 85) may carry the command message if the command message is small enough.

This example method further provides that the network address of an upstream augmentation unit may be associated with the command message and the resulting one or more data packets (step 90). These data packets may then be used to modulate an upstream data carrier signal (step 95). The modulated upstream data carrier may then be conveyed to a medium connecting the content receiver to the augmentation unit (step 100).

FIG. 5 is a flow diagram that depicts one example method for receiving commands from a downstream apparatus, such as a content receiver, according to the present invention. In order to receive a command from a downstream apparatus, an augmentation unit may first receive a modulated carrier signal (step 105). This signal is the upstream modulated data carrier generated by the content receiver. This signal may also be an upstream modulated carrier signal forwarded by an augmentation unit that may be downstream of a particular augmentation unit. This forwarding of a command by one augmentation unit to another may be necessary when a first augmentation unit is not the intended recipient of a particular command message.

Once a modulated signal is received, it may be demodulated (step 110). As a result of demodulation, a digital bit stream is recovered from an upstream data carrier signal. According to this example method, the digital bit stream may then be framed into data packets (step 115). Network messages may then be assembled from individual data packets (step 120). Where a network message comprises a command message, the method of the present invention provides for execution of the command encapsulated in the network message (step 125).

FIG. 6 is a flow diagram that depicts one illustrative method for processing a “record” command according to the present invention. According to one derivative of the present method, a command message received from a content receiver or other downstream apparatus may comprise a “record” command. This type of command may normally be processed by an augmentation apparatus that provides video recording functionality. Upon receiving a command (step 130), the method provides for recognizing a “record” command (step 135). If, indeed, a “record” command is recognized, one example method teaches that a content stream may be received from an upstream content source (step 140). The content stream may then be recorded (step 145). Recording may continue until the content stream is exhausted or a stop-record command is received (step 150).

In order to receive a content stream from an upstream content source, at least two variations of the present method may be employed. One such illustrative method may be used to receive a content stream disseminated from the content source using analog distribution. An alternative method may be used to receive digitally distributed content.

According to either of these alternative methods, a modulated carrier signal may be received and demodulated. In those instances where an analog content signal is received, the method provides for digitizing the demodulated analog content signal and then compressing the digitized signal. One variation of this method provides for compressing the digitized signal in accordance with an MPEG compression standard. In the case where content is distributed digitally, an alternative method provides that a modulated carrier signal may be demodulated so as to recover a digital transport stream comprising a plurality of digital content channels. In furtherance of this example method, a single content stream may be extracted from the transport stream. This may be in the form of a compressed content stream. A compressed content stream may be in an MPEG compression format. Hence, according to either of these alternative methods, a digital content stream representative of the content to be recorded may be prepared according to a modulated signal received from an upstream path 35. This digital content stream may then be recorded.

FIG. 7 is a flow diagram that illustrates one example method for processing a “play” command according to the present invention. According to one possible embodiment, an augmentation unit may provide personal video recording functionality. In order to provide this type of functionality, an augmentation unit may need to respond to a “play” command that may be received from a content receiver or other apparatus disposed downstream of the augmentation unit.

According to one illustrative method of the present invention, a command may first be received (step 155). If the command is a “play” command (step 160), then the process may determine what media content is to be played, i.e. presented to a user (step 170). After having determined the content that is the subject of the play command, the content may be retrieved (step 175) and directed to a downstream content receiver (step 180). Content may be presented until the content stream is exhausted or until a “stop” command is received (step 185).

In one variation of the present method, the content that is to be played may be determined by extracting a content name from the “play” command. In this case, the “play” command comprises a content name field. According to another variation of the present method, a play command may actually cause continued presentation of a content stream where earlier presentation was interrupted by a “stop” command. This, effectively, behaves like a “resume” command.

FIGS. 8 and 9 are flow diagrams that depict two example variations of the present method of directing a content stream to a downstream content receiver. Two example derivative methods of the present invention provide for directing content to a downstream content receiver by retrieving a digital content stream from a content storage unit that may be managed by an augmentation unit. Once the content stream is retrieved, it may be used to modulate a carrier signal (steps 190 or 205). According to one variation of the present method, QAM modulation may be used.

In some cable television systems, a plurality of content streams are distributed from a head-end using a single medium. This may be coaxial cable, but the scope of the present invention is not intended to be limited to the use of any one type of physical medium. The medium typically carrier a plurality of modulated carrier signals at different frequencies. These correspond to the plurality of content streams sourced by the head-end. According to one example method of the present invention, a modulated carrier generated to carry a playback content stream may be combined with these other modulated carriers (step 195) before it is conveyed to a medium (step 200) that connects an augmentation unit to a downstream content receiver. In yet another variation of the present method, the carrier signal generated to convey the playback content stream may be selected (210) in lieu of the multiple carrier signals received from the head-end (step 215). Once selected, the playback content stream carrying signal may be conveyed to a medium connecting the augmentation unit to a downstream content receiver (step 220).

FIG. 10 is a block diagram the depicts one possible structure of an augmentation apparatus according to the present invention. According to this one illustrative embodiment, an augmentation unit may comprise a processor 245 that is able to execute firmware that may be stored in a memory 250. Firmware typically comprises instruction sequences that may be executed by the processor 245. These instruction sequences may be organized into functional components called “modules”. The memory 250 also comprises the augmentation unit. A downstream interface 240 may further comprise the invention.

According to one example embodiment of an augmentation unit of the present invention, commands may be received from a content receiver that is connected to a downstream interface 240 by way of a downstream path 242 (where “downstream” is relative to the augmentation unit). As a command is received, it may be executed if it is addressed to the augmentation unit that received it.

According to one illustrative embodiment of the present invention, firmware stored in the memory 250 may comprise a command executive. The command executive may be executed by the processor 245. When so executed, the command executive may minimally cause the processor 245 to receive a command from the downstream interface 240. According to this embodiment, the downstream interface provides commands to the command processor if they are properly addressed. If a command that is received by the downstream interface 240 is not properly addressed, the command may be forwarded by directing the command to an upstream interface 230 that may further comprise the invention.

At least one example embodiment of an augmentation unit may receive a plurality of modulated carrier signals from an upstream content source, for example a cable television system head-end. In this case, the upstream interface 230 receives these modulated carrier signals by way of an upstream path 232. These carrier signals are typically forwarded by way of a forward RF path 265 to one or more downstream interfaces 240.

The augmentation unit of the present invention may further comprise a content receiver initiation unit. This may be embodied as a module of software that may further comprise the firmware stored in the memory 250.

This software module may be referred to as the content receiver initiation module. According to one example embodiment of the present invention, the processor may execute the content receiver initiation module and this may minimally cause the processor 245 to retrieve a updated receiver firmware image and then direct this firmware image to a downstream content receiver by way of the downstream interface 240.

The updated receiver firmware image may be received from a cable television system head-end by way of the upstream interface 230. In an alternative embodiment of the invention, the updated receiver firmware image may be stored in an augmentation unit, for instance in the memory 250, upon manufacture.

The updated firmware image for a content receiver typically comprises modules that, once executed by a processor in the content receiver, enable the content receiver to forward commands to an upstream augmentation unit. One alternative embodiment of the present invention teaches that the updated receiver firmware image comprises a wholly new firmware image that may be used to entirely replace the firmware image stored in a content receiver.

According to another embodiment of the present invention, the updated firmware image comprises a firmware “patch”. A firmware patch may comprise one or more software modules that may be used to enhance the capabilities of existing firmware stored in a content receiver without requiring the complete replacement of the firmware. In order for this type of “patch” to be installed in a downstream content receiver, the existing firmware in the content receiver must enable a processor in the content receiver to detect and execute firmware patches. Where this capability is not supported by existing firmware in a content receiver, a patch may comprise software modules that may replace only a portion of said existing firmware.

Various embodiments of a replacement firmware image for a content receiver may comprise modules that enable a processor in a content receiver to communicate with other devices attached to a cable television system using network protocols. Hence, one alternative embodiment of the replacement firmware image comprise a network protocol module. The network protocol module may cause the processor in the content receiver to fragment command messages that may be used to forward a command “upstream” into one or more data packets. These data packets may then be used to modulate a carrier that may be conveyed to an upstream augmentation unit.

FIG. 11 is a block diagram that depicts one possible structure of a downstream interface according to the present invention. The processor 245 comprising the augmentation unit of the present invention may convey messages to a downstream content receiver using the downstream path 242 by way of the downstream interface 240. According to this embodiment, message data from the processor 245 may be directed by way of an internal data bus 260 to a downstream interface 240. This message data may be in the form of data packets as described below. The packets comprising message data 425 may be directed to a modulator 430 that may comprise the downstream interface.

The downstream interface may further comprise a frequency-sensitive steering filter 400. This type of filter is also known as a “diplex filter”. The modulator 430 may generate a modulated downstream data carrier signal 435 according to the data packets it receives from the processor 245. This signal may be directed to the diplex filter 400. The modulated downstream data carrier signal may then be conveyed to a downstream path 242. According to at least one embodiment of the present invention, the modulator 430 may comprise a QPSK modulator.

According to one alternative embodiment of the present invention, the downstream interface may further comprise a signal splitter 450 disposed between the output of the diplex filter 400 and the downstream path 242. A modulated carrier received by way of the downstream path 242, for example from a downstream content receiver, may be diverted by the signal splitter 450 to a tuner 410 that may further comprise the invention. The tuner 410 may then selectively amplify the upstream data carrier signal 455 and direct this to a demodulator 415 that may further comprise the downstream interface. The demodulator may then direct a digital bit stream to a packet framer 422 that may further comprise the invention. The packet framer 422 may then generate data packets from the digital bit stream extracted from the upstream data carrier signal 455 received by way of the downstream path 242. The data packets 420 may then be directed to the processor 245 comprising the augmentation unit using the internal data bus 260.

FIG. 12 is a block diagram that depicts one possible structure of an upstream is interface according to the present invention. Because the upstream path 232 may be used to receive a plurality of content carrying carrier signals and a downstream data carrier and may also be used to convey an upstream data carrier signal, the signal path may be partially formed by a diplex filter comprising the upstream interface. The input of the diplex filter may be connected to the upstream path 232. When a processor 245 comprising an augmentation unit needs to direct network messages upstream, data packets 345 may be directed to a modulator 350 that may further comprise the upstream interface. This modulator may generate an upstream data carrier signal according to the data packets 345. The diplex filter directs the upstream data carrier signal outward from the augmentation unit into the upstream path 232.

When a downstream data carrier signal arrives at the diplex filter 300, it is directed to a first signal splitter 302 comprising the invention. The first signal splitter 302 diverts the downstream carrier signal to a first tuner 360 comprising the upstream interface. The first tuner 360 may then selectively amplify the downstream carrier signal and direct the amplified carrier signal to a first demodulator 360. The first demodulator 360, that may further comprise the upstream interface, may recover a digital bit stream 370 from the downstream data carrier signal received from the upstream path 232. The first demodulator 360 may comprise a QPSK demodulator. The digital bit stream 370 may be framed into data packets 377 by a packet framer 372 that may also comprise the upstream interface. Data packets 377 may be directed to the processor 245 by way of the internal data bus 260.

FIG. 12 further illustrates that an upstream interface may further comprise a second signal splitter 310. The output of the diplex filter 300 typically delivers a plurality of content carrying modulated carrier signals that may be received from the upstream path 232. This plurality of content carrying signals may be split into one or more forward RF paths 265 each of which may be directed to a downstream interface 240. One of these forward RF paths may be directed to a second tuner 315 that may further comprise the upstream interface. This second tuner may be directed by the processor 245 to select one carrier signal according to carrier frequency 320. Once the tuner selects the carrier signal from the plurality that may be present in the forward RF signal path, it may be demodulated in order to recover a content stream.

According to at least one embodiment of the present invention, a demodulator comprising the upstream interface may demodulate a carrier signal that carries an analog signal. In this case, the upstream interface may further comprise a digitzer. The digitizer may digitize the analog signal. The digitized analog signal may then be directed to a compression unit that may further comprise the upstream interface. In one alternative embodiment of the present invention, the compression unit may compress the digitized analog signal according to an MPEG compression standard in order to develop a digital content stream.

In yet another alternative example embodiment of the present invention, the demodulator may demodulate a carrier signal that is carrying a digital content transport stream. In this case, the demodulator may comprise a QAM demodulator 325. The demodulator typically recovers a digital content transport stream comprising a plurality of individual program content streams. The processor 245 may direct a program identifier (PID) filter 330 to select one program from the transport stream according to a PID selector 335. This selected program stream typically comprises a compressed digital content stream. This content stream may be compressed according to an MPEG compression standard.

FIG. 10 shows that an augmentation unit may further comprise a recording management unit 280. According to one alternative embodiment of an augmentation unit, the command executive module may recognize a “record” command that may be received by way of the downstream path 242. In this case, the command executive may minimally cause the processor 245 to direct the digital content stream 231 from the upstream interface to the recording management unit 280. The recording management unit may then store the digital content stream 231 on computer readable media 285 that may further comprise the augmentation unit of this example embodiment of the invention.

Once content is stored on the computer readable media 285, it may be retrieved so that it may be directed to a downstream content receiver. In one alternative embodiment of the present invention, the command executive may recognize a “play” command that may be received by way of the downstream path 242. Once the command executive recognizes the “play” command, it may minimally cause the processor 245 to determine what content must be presented to a user and command the recording management unit 280 to retrieve the required content from the computer readable media 285 and direct said content to a downstream interface 240.

FIG. 11 also shows that a downstream interface may further comprise a second modulator 470. The second modulator 470 may receive a digital content stream from the recording management unit 280. The digital content stream may be encapsulated in a digital content transport stream. The second modulator 470 may then generate a content carrying carrier signal according to the content stream. According to one example embodiment of the present invention, the second modulator 470 may be a QAM modulator. The modulated content carrying carrier signal may be at a particular distribution frequency and may be directed to a downstream path 242.

One example embodiment of the present invention may be used to support dissemination of a content stream using analog distribution. Hence, a downstream interface may further comprise a graphics generator. Said graphics generator may receive a content stream from the recording management unit 280. An analog content signal may be generated according to the content stream. In this example embodiment of the invention, the second modulator may be an analog television modulator that generates an analog television signal at an IF frequency. This IF signal may then be converted to a distribution frequency and directed to a downstream path 242.

According to one alternative embodiment of a downstream interface, the modulated content carrying carrier signal may be directed to a downstream path 242 by directing the content carrying carrier signal to a combiner 480 that may comprise the downstream interface. The combiner 480 may combine the content carrying signal generated by the second modulator 470 with a plurality of modulated carrier signal that may be received in the downstream interface by way of a forward RF path 265. In yet another alternative embodiment of the present invention, the combiner may be replaced by a PIN diode switch 485. The PIN diode switch 483 may select the content carrying signal generated by the second modulator 470 in lieu of the plurality of modulated carrier signal that may be received in the downstream interface by way of a forward RF path 265. The combiner may be a used in embodiments of the invention where a multiple downstream content receivers may be attached to a particular downstream path 242 as depicted in FIG. 3. The PIN diode switch may be a used in embodiments of the invention where a single downstream content receiver may be attached to a particular downstream path 242 as depicted in FIG. 2.

FIG. 13 is a data flow diagram that depicts one possible means for network protocol communications between a content receiver and an augmentation unit according to the present invention. According to one possible embodiment, an upstream apparatus 500 may be connected to a downstream apparatus 505 using a connection. Said connection may be a coaxial cable. Said connection may be used to convey modulated data carrying signals between the two apparatus (500 and 505). In one possible embodiment of the present invention, the upstream apparatus may be an augmentation unit whereas the downstream apparatus may be a content receiver. The content receiver may be a set-top-box or it may be any other broadcast content receiver, for example a cable-ready TV.

According to the teachings of the present method, a downstream apparatus may receive a command by means of a command interface 510. The downstream apparatus may comprise a processor that is capable of executing instruction sequences also known as modules. Once executed by the processor in the downstream apparatus 505, a command parser module 515 may minimally causes the processor to receive a command from the command interface 510. If the command parser 515 recognizes that the command should be forwarded upstream, as potentially enabled by a firmware patch, the command parser 515 may generate a command message representing the command and direct this to a protocol module 520. The protocol module may implement any convenient protocol, for example TCP/IP or ALOHA packet based protocol, NEED ACRONYM DEFINITIONS. It should be noted that some cable television systems use the aforementioned ALOHA protocol, but the scope of the present invention is not be limited to this or any other example network protocol introduced here.

The protocol module 520 may cause the processor in the downstream apparatus 505 to fragment the command message into one or more data packets that can then be conveyed to a modulator 525. The modulator may generate an upstream data carrier signal 530 according to the teachings of the present invention. Said data packets are typically identifiable so that their receipt may be confirmed when they arrive at an upstream apparatus 500.

A processor in the upstream apparatus 500 may extract data packets from the upstream data carrier signal 530 using a demodulator 535. The data packets may be received by the processor comprising the upstream apparatus 540 as it executes its own protocol module 540. This upstream apparatus protocol module 540 may need to acknowledge or request retransmission of a data packet. This may be done by sending a message to the downstream protocol module 520. This may be accomplished by sending a data packet to a modulator 550 comprising the upstream apparatus 500, which generates a downstream data carrier signal. The downstream data carrier signal 560 may be received by a demodulator 565 comprising the downstream apparatus 505, which may then extract a data packet from the downstream carrier signal 560. The data packet may the be directed to the protocol module 520 executing in the downstream apparatus 505 as an acknowledgement or request for retransmission of an earlier data packet conveyed to the upstream protocol module 540.

As the processor in the upstream apparatus 500 continues to execute the protocol module 540, it may assemble a command message from data packets received from the protocol module 520 in the downstream apparatus 505. Command messages may then be directed to a command executive 545 that may be executed by the processor comprising the upstream apparatus 500.

Alternative Embodiments

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents.

1. A method for expanding the functionality of a content receiver comprising the steps of:
receiving a command from a downstream content receiver; and
executing the command if the command is not directed to a server further upstream.

2. The method of claim 1 further comprising the step of directing an unexecuted command to a server further upstream.

3. The method of claim 2 wherein the step of directing an unexecuted is command to a server further upstream comprises the steps of:
receiving data packets addressed to an upstream augmentation unit;
generating a modulated carrier signal according to the data packets; and
conveying the modulated carrier signal to an upstream interface.

4. The method of claim 1 further comprising the step of configuring a downstream content receiver to forward user commands upstream if the downstream content receiver had not been previously configured to do so.

5. The method of claim 4 wherein the step of configuring a downstream content receiver comprises the steps of:
installing a firmware patch into the downstream content receiver that minimally causes a processor in the downstream content receiver to:
fragment an unexecuted command into one or more data 30 packets;
generate a modulated carrier signal according to the data packets; and
convey the modulated carrier signal an upstream augmentation unit.

6. The method of claim 1 wherein the step of receiving a command from a downstream content receiver comprises the steps of:
receiving a data packet from a downstream interface according to a delivery address;
associating the data packet with a network message; and
directing a network message to a command parser that executes a command contained in the network message.

7. The method of claim 6 wherein the step of receiving a data packet from a is downstream interface comprises the steps of:
receiving a modulated carrier signal;
extracting a digital bit stream from the modulated carrier; an
framing the bit stream into data packets.

8. The method of claim 1 wherein the command received is ac record command and the step of executing the command comprises the steps of:
receiving a content steam from an upstream signal source; and
recording the content stream.

9. The method of claim 1 wherein the command received is a play command and the step of executing the command comprises the steps of:
determining what content is requested for play;
retrieving the requested content; and
directing the retrieved content to the downstream content receiver.

10. The method of claim 9 wherein the step of directing the retrieved content to the downstream content receiver comprises the steps of:
modulating a carrier signal according to the content stream;
combing the modulated carrier signal with a multiple carrier signal; and
conveying the combined signal to the downstream content receiver.

11. The method of claim 9 wherein the step of directing the retrieved content to the downstream content receiver comprises the steps of:
modulating a carrier signal according to the content stream; and
conveying the modulated carrier signal to the downstream content receiver in lieu of a multiple carrier signal.

12. A content receiver augmentation unit comprising:
downstream interface; and
command executive that receives a command from the downstream interface and executes the command if the command is not directed to a server further upstream.

13. The content receiver augmentation unit of claim 12 further comprises an upstream interface and wherein the command executive comprises a command forwarding unit that directs unexecuted commands to the upstream interface.

14. The content receiver augmentation unit of claim 13 wherein the command forwarding unit receives data packets addressed to an upstream augmentation unit and directs these to the upstream interface and wherein the upstream interface comprises:
modulator that generates a modulated carrier signal according to the data packets; and
multiplexing filter capable of directing the modulated carrier into an upstream path.

15. The content receiver augmentation unit of claim 12 further comprising a content receiver initiation unit that configures a downstream content receiver to forward commands if the downstream content receiver has not been previously configured to do so.

16. The content receiver augmentation unit of claim 15 wherein the content receiver initiation unit configures a downstream content receiver by:
installing a firmware patch into the content receiver that minimally causes a processor in the content receiver to:
fragment an unexecuted command into one or more data packets;
generate a modulated carrier signal according to the data packets; and
convey the modulated carrier signal to an upstream augmentation unit.

17. The content receiver augmentation unit of claim 13 wherein the downstream interface comprises:
data packet receiver that receives data packets according to a delivery address; and
message assembly unit that assembles one or more received data packets into a network message and wherein the command executive comprises a command parser that receives the network message and executes a command contained therein.

18. The content receiver augmentation unit of claim 17 wherein the data packet receiver comprises:
demodulator that generates a digital bit stream according to a modulated carrier; and
data packet framer that generates data according to the digital bit stream.

19. The content receiver augmentation unit of claim 12 further comprising a content storage unit and wherein the upstream interface comprises a content receiver that is capable of receiving a content stream from an upstream source and directs said content stream to the content storage unit if the command executive receives a record command.

20. The content receiver augmentation unit of claim 12 further comprising a content storage unit wherein the command executive directs the content storage unit to direct a content stream to the downstream interface according to a received command if said received command is a play command.

21. The content receiver augmentation unit of claim 20 wherein the downstream interface comprises:
modulator that generates a modulated signal according to a content stream; and
signal combiner capable of combing the modulated signal with a multiple carrier signal.

22. The content receiver augmentation unit of claim 20 wherein the downstream interface comprises:
modulator that generates a modulated signal according to a content stream; and
signal selector capable of selecting the modulated signal in lieu of a multiple carrier signal.
